(19) United States
(12) Patent Application Publication
(10) Pub. No.: US 2007/0226983 A1
(43) Pub. Date: Oct. 4, 2007

(54) Gas assist molded wiper arm

(76) Inventor: Christopher Reynolds, West Bloomfield, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/395,910

(22) Filed: Mar. 31, 2006

(51) Int. Cl. B60S 1/34; B60S 1/52; B29D 22/00; B23P 11/02

(52) U.S. Cl. 29/447; 15/250.04; 15/250.351; 264/572; 29/527.1

(57) ABSTRACT

A wiper apparatus for a window includes a wiper arm having an injection molded body with a chamber formed therein. The chamber is formed with a gas and the chamber selectively directs a fluid to a nozzle.

### TECHNICAL FIELD

The present invention generally relates to wipers for vehicles, and more specifically to injection molded wiper arms.

### BACKGROUND

Wiper assemblies for vehicles are typically provided for the windshield, and often for the rear window. Typically, wiper assemblies include an operable member, generally a motor, to provide an oscillatory rotary motion, a wiper arm connected to the motor, and a wiper blade connected to the arm and positioned to sweep, or traverse, the surface of the window to remove water and other undesired materials therefrom. Wiper arms may include a plurality of components that require multiple steps to form and assemble. Many wiper assemblies are provided with a washer system that directs a washer fluid on the surface that the wiper traverses to wet the window surface and aid in the removal of undesired materials. Some wipers, such as rear window wipers, may be provided with a hose that is attached to the wiper arm to deliver the washer fluid to the surface. Typically, the hose is connected to a nozzle that is also supported by the wiper arm.

These wiper arms are typically elongated C-channels having a three walled structure forming a open slot along the length of the arm. The hose may be routed within this slot. However, a C-channel structure is not optimized for structural rigidity in uses that include elongated arms. What is needed, therefore, is a wiper arm that provides greater structural rigidity while not increasing mass, and preferably reducing mass. A favorable wiper arm would also include a reduction in components required for assembly resulting in a reduction in assembly time and costs.

### SUMMARY

An illustrative embodiment includes a wiper apparatus for a window. The apparatus includes a wiper arm having an injection molded body with a chamber formed therein. The chamber is formed with a gas and the chamber selectively directs a fluid to a nozzle.

Another illustrative embodiment provides a wiper apparatus. The apparatus includes a generally elongated body member having a chamber formed therein. The body member has a first aperture connected to the chamber and a second aperture connected to the chamber. The apparatus also includes a hose coupled to the body member to provide a fluid to the chamber via the first aperture, and a nozzle connected to the body member to exhaust a fluid from the second aperture.

An exemplary embodiment provides a method of forming a windshield wiper apparatus. The method includes injecting a heated material into a mold cavity and injecting a fluid into the material to expand the polymer to form a member having an external surface that generally conforms to a surface of the mold cavity. The fluid forms a chamber in the member. The method also includes forming a first aperture in the member that is connected to the chamber, and forming a second aperture in the member that is connected to the chamber. The method further includes providing a nozzle in one of the first aperture and the second aperture of the member that is in fluid connection with the chamber.

### BRIEF DESCRIPTION OF THE DRAWINGS

Referring now to the drawings, preferred illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are not intended to be exhaustive or otherwise limit or restrict the claims to the precise forms and configurations shown in the drawings and disclosed in the following detailed description.

FIG. 1 is a perspective view of a wiper arm according to an embodiment.

FIG. 2 is an enlarged view of the wiper arm of FIG. 1, taken along the line 2-2.

FIG. 3 is an enlarged partial sectional view of the wiper arm of FIG. 1, taken along the line 3-3.

FIG. 4 is a partial sectional view of the wiper arm of FIG. 1, taken along the line 4-4.

FIG. 5 is an enlarged perspective view of a nozzle according to an embodiment.

FIG. 6 is a partial sectional view of a mold assembly according to an embodiment.

FIG. 7 is a partial sectional view of the mold assembly of FIG. 6.

FIG. 8 is a top view of a lower mold portion illustrated in FIG. 6.

### DETAILED DESCRIPTION

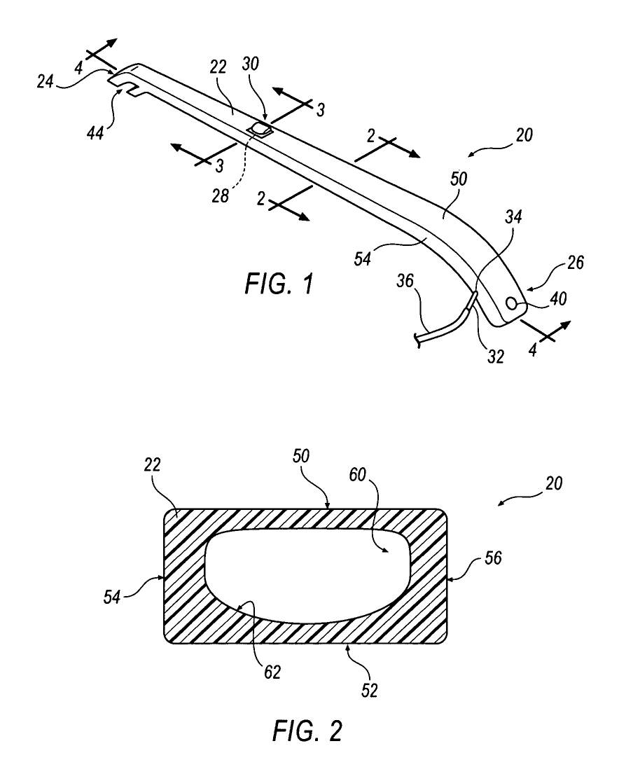

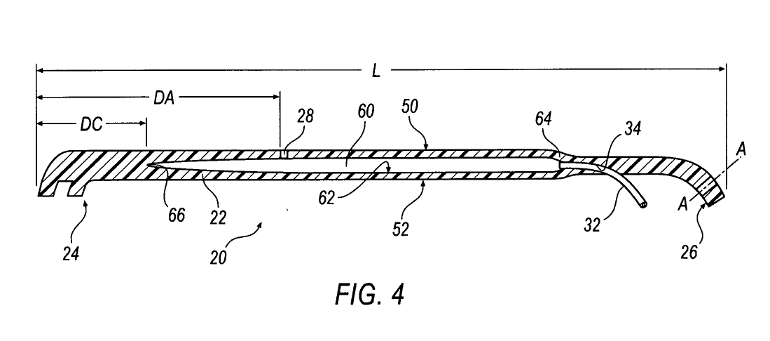

FIG. 1 illustrates a windshield wiper arm, or wiper member, 20. The arm 20 includes an elongated body 22 having a blade end 24 and an attachment end 26. The body 22 further includes a nozzle aperture 28 having a nozzle 30 extending therefrom, and a inlet tube 32 interconnecting an arm inlet aperture 34 of the body 22 to a hose 36, as described in more detail below. The attachment end 26 includes an attachment aperture 40, having an axis A-A (FIG. 4), for attaching the arm 20 to an operable member of a vehicle (not shown) and the blade end 24 includes a formed, pivotal connection for connecting to a wiper blade (not shown). The body 22 also includes an upper surface 50, a lower surface 52, a first lateral surface 54, and a second lateral surface 56.

Generally, the wiper arm 20 is a component of a wiper system including a wiper assembly that includes the wiper arm 20, the wiper blade, a motor connected to the attachment aperture 40 to provide rotary oscillatory motion about the axis A-A. The wiper system may also include a washer fluid system including a reservoir (not shown), the hose 36, and the nozzle 30. The wiper system also includes a control system for operating the wiper assembly and a control system for operating the washer fluid system.

FIGS. 2-4 illustrate additional details about body 22. In one embodiment, body 22 includes a chamber 60 formed therein. As best seen in FIG. 4, chamber 60 includes a chamber surface 62, a first end 64, and a second end 66. The second end 66 of chamber 60 is spaced from the blade end 24 a distance DC. The nozzle aperture 28 is spaced from the blade end 24 a distance DA. As illustrated, the distance DA is greater than the distance DC. Preferably, the chamber 60 extends more than half of the overall length L of the arm 20.

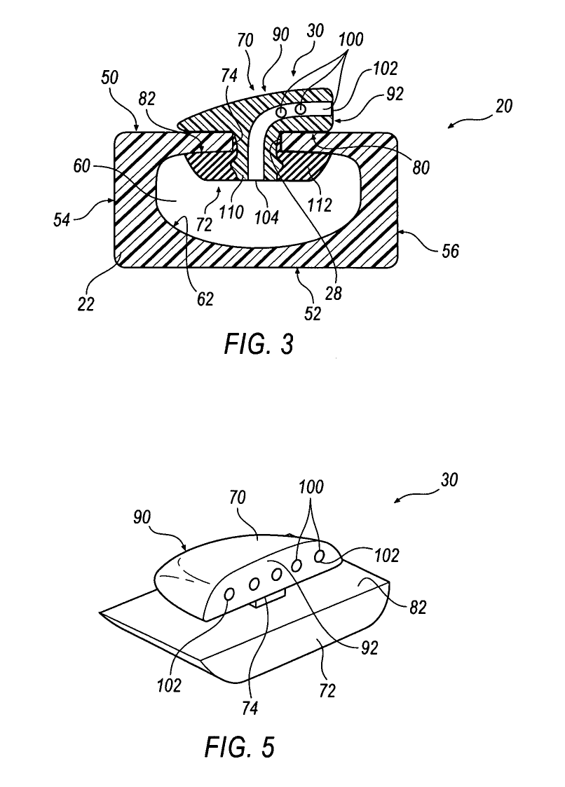

FIGS. 3 and 5 illustrate the nozzle 30 to include a first portion 70, a second portion 72, and an interconnecting portion 74. The first portion 70 includes an outer mating surface 80, and the second portion 72 includes an inner mating surface 82. The first portion also includes an outer surface 90 and a nozzle surface 92. The nozzle 30 includes a passageway 100 that extends from a plurality of nozzle outlet apertures 102 formed in the nozzle surface 92, through the interconnecting portion 74, to a nozzle inlet aperture 104 formed in the second portion 72.

The nozzle 30 may be molded of a rubber or a polymer, or may be formed of a metal. The second portion 72 may include an inner portion 110 that is integrally formed with the first portion 70, and an outer portion 112, surrounding the inner portion 110 and defined, in part, by the inner mating surface 82. The outer portion may be a rubber or elastomer that is overmolded onto the inner portion 110. Preferably, fluid pressure within the chamber 60 will exert a force on the outer portion 112, thereby providing an overmolded sealing portion, thereby sealing the inner mating surface 82 to a portion of the chamber surface 62 that surrounds the nozzle aperture 28.

Interconnecting portion 74 may be cylindrical or cube shaped, as illustrated. Preferably, the connection between the nozzle 30 and the arm 20 includes some type of interfering surfaces that prevent the nozzle 30 from undesirably rotating within the nozzle aperture 28. Alternatively, the nozzle 30 may include a plurality of nozzle outlet apertures 102 that are directed in various orthogonal directions toward the desired surface regardless of the orientation of the nozzle 30 within the nozzle aperture 28. Additionally, the nozzle 30 may be threaded or glued to the arm 20, or may be a multi-piece assembly that is adjustable for varying distances between surfaces 80 and 82, as desired.

The angular velocity of the arm 20 about the axis A-A of the aperture 40 during wiper motion creates an angular acceleration on the volume of fluid within the chamber 60. Therefore, the pressure exerted through hose 36 on the fluid within the chamber 60 to force fluid to exit the nozzle 30 may be lower as the angular acceleration creates additional pressure within the chamber 60. When the washer system does not require fluid to exit the nozzle 30 as the wiper arm is rotating and counter-rotating to permit the wiper blade to traverse a windshield, the fluid flow through the hose 36 is stopped, such as by a valve (not shown), thereby requiring that pressure due to the angular acceleration on the fluid within the nozzle 30 overcome the shear forces of surface tension within the passageway 100.

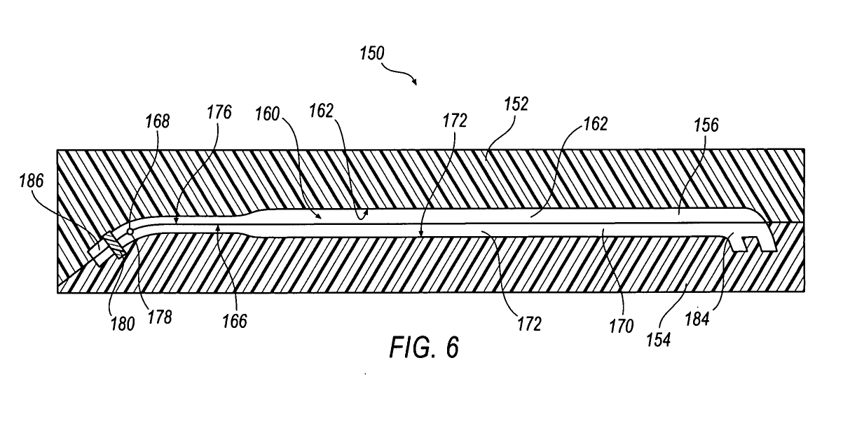

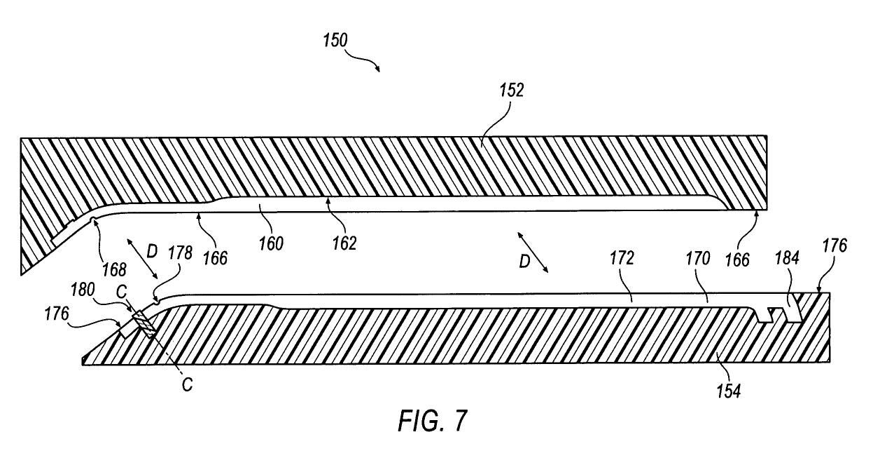

FIGS. 6 and 7 illustrate a mold 150 that may be used to form the arm 20. The mold 150 includes an upper mold portion 152 a lower mold portion 154, and a mold cavity 156. The upper mold portion 152 includes an upper cavity portion 160 having an upper cavity surface 162, and a lower mold mating surface 166 having an upper tube channel portion 168.

As seen in FIGS. 6-8, the lower mold portion 154 includes a lower cavity portion 170 having a lower cavity surface 172, and an upper mold mating surface 176 having a lower tube channel portion 178. A molding pin 180 having an axis C-C may extend from the lower cavity surface 172 to form a locating aperture (not shown) in an unfinished blank (not shown) to facilitate finishing of the attachment aperture 40 in arm 20. The mold cavity 156 includes a blade end forming surface 184 and an attachment end forming surface 186.

Collectively, upper cavity portion 160 and lower cavity portion 170 generally define the mold cavity 156. Generally, upper mold portion 152 and lower mold portion 154 are separated in a direction D that is generally parallel to the axis C-C of the molding pin 180, if provided.

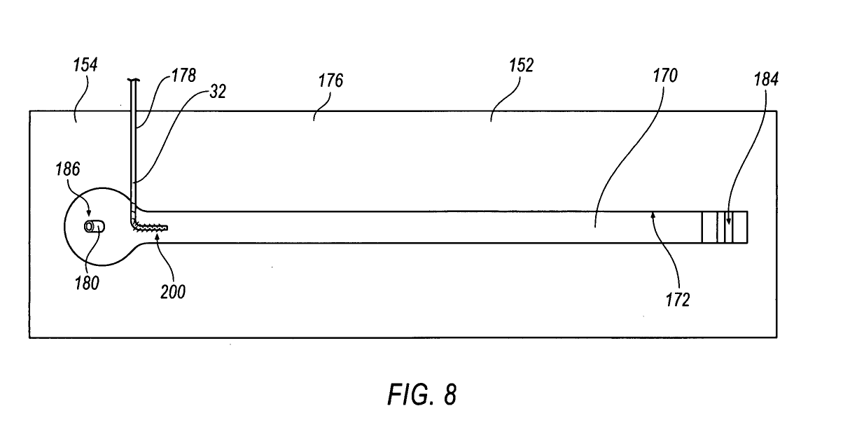

FIG. 6 illustrates the mold 150 closed without a tube 32 interposed therein. FIG. 8 illustrates the lower mold portion 154 with a tube 32 positioned therein prior to closing the mold 150 and injecting any melt. As best illustrated in FIG. 8, the tube 32 is preferably a metallic hollow tube with a knurled outer surface 200 to permit the melt to readily bond thereto while preventing pullout or rotation of the tube 32 after the melt has cured and the arm 20 is formed.

One embodiment of a method to form a wiper assembly is as follows. The tube 32 is inserted into the lower mold portion 154 as shown in FIG. 8. The mold 150 is then closed and a melt (not shown) is injected into the mold cavity 156. Preferably, the melt is injected near the attachment end 26. Once a predetermined amount of melt is injected into the mold cavity 156, the melt injection is stopped. Preferably, the melt has filled the portion of the mold cavity 156 that includes the attachment end forming surface 186 and the portion of the mold cavity 156 that includes the blade end forming surface 184 has not been completely filled.

Thus filled, the melt is permitted to partially solidify and a gas (not shown) is injected into the mold 150. Since the melt will begin to solidify in portions that contact surfaces 162, 172, the gas will not separate the melt from surfaces 162, 172. The gas will not mix with the melt, but will take the path of least resistance through the melt, thus forming the chamber 60. As the gas flows into the mold 150, the gas is preferably directed to either the attachment end 26 or the blade end 24 in a central portion of the mold cavity 156. Thus directed, the gas will not separate the melt from the surfaces 162, 172, but will expand generally along the line of insertion into the mold cavity 156 thereby pressing the melt toward the surfaces 162, 172.

When the gas is injected through the tube 32, the tube 32 is used as a gas injection nozzle and the melt is forced toward and into contact with the blade end forming surface 184, thus ensuring that the melt contacts all portions of the surfaces 162, 172. Accordingly, in the absence of the gas, no chamber 60 would be formed within the arm 20. Also when the gas is injected through the tube 32, the tube 32 forms the arm inlet aperture 34 in the arm 20 as the melt surrounds the tube 32.

When a desired amount of gas is inserted into the mold cavity 156, the mold cavity 156 is closed and the melt is permitted to solidify. When the melt material is sufficiently solidified, or otherwise cured, the gas is vented, and the mold 150 may then be opened (FIG. 7) and the blank removed. The blank is then finished to provide an arm 20. Finishing steps may include inspection, final boring of apertures 28, 40, insertion of nozzle 30 in nozzle aperture 28, and pivotally attaching a wiper blade to arm 20.

The chamber 60 permits the arm 20 to have a reduced weight while providing greater structural rigidity as is common with hollow, elongated structures. Additionally, chamber 60 permits the use of less material. The thinner walls, as compared to an item with no chamber, will also result in less cure time for the melt, or resin.

While other injection molding methods that produce chambers or cavities within items may be used, such as blow molding, gas assist injection molding (GAIM) is preferably used. Preferably, the gas is nitrogen that is heated prior to injection into mold 150. Also preferably, the melt is a composite material and may include Nylon, PVC, and other materials that may be gas-assist injection molded. Additionally, the gas may be injected by a dedicated gas injection nozzle (not shown) that is then removed from the molded blank. Any gas injection nozzle aperture, such as the inlet aperture 34, created in the blank that extends to the chamber 60 may be filled. If the gas injection nozzle aperture is to be used to route washer fluid to the chamber 60, a tube, such as tube 32, may be inserted into the gas injection nozzle aperture formed by the removed gas injection nozzle, or a hose, such as the hose 36 may be connected to the arm 20 without the use of a tube 32. While the nozzle 30 is described as an insert portion to be attached to the arm 20 after molding, the nozzle 30 may be provided by forming a passageway 100 in a desired location of the body 22.

Alternatively, the gas injection nozzle may be a part of the upper mold 152, positioned such that the gas injection nozzle forms the nozzle aperture 28 when forming the arm 20, and the gas is directed toward the molding pin 180 within the mold 150 to form the chamber 60. A nozzle, such as the nozzle 30 may be glued within the nozzle aperture formed by the gas injection nozzle, and an inlet aperture, such as the inlet aperture 34, formed by

In the embodiment illustrated, the attachment end 26 may include an attachment clip that may be inserted into the mold cavity 156 and molded into the attachment end 26. the attachment clip facilitates the attachment of a wiper blade to the arm 20. Collectively, the wiper blade and the wiper arm 20 form a wiper apparatus.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A wiper apparatus comprising:
a generally elongated body member having a chamber formed therein, the body member having a first aperture connected to the chamber and a second aperture connected to the chamber;
a hose coupled to the body member to provide a fluid to the chamber via the first aperture; and
a nozzle connected to the body member to exhaust a fluid from the second aperture.

2. The apparatus of claim 1, wherein the nozzle is an opening of the second aperture.

3. The apparatus of claim 1, further comprising a tube connected to the body member, wherein the tube selectively directs a washer fluid through the to the chamber.

4. The apparatus of claim 3, wherein the chamber is formed by a gas directed by the tube.

5. The apparatus of claim 1, wherein the chamber is formed by a gas directed through the first aperture.

6. The apparatus of claim 1, wherein the chamber is formed by a gas injected into a heated material.

7. The apparatus of claim 1, wherein the nozzle includes an overmolded sealing portion.

8. A wiper apparatus for a window comprising:
a wiper arm having an injection molded body with a chamber formed therein, wherein the chamber is formed with a gas, and the chamber selectively directs a fluid to a nozzle; and
a wiper blade mounted to the wiper arm.

9. The apparatus of claim 8, further comprising a passageway formed in the wiper arm, wherein the passageway provides an exit path for a fluid within the chamber.

10. The apparatus of claim 8, wherein the wiper arm is selectively connected to a mechanical system for rotary oscillatory motion.

11. The apparatus of claim 8, further comprising a tube connected to the wiper arm, wherein the tube selectively directs a washer fluid to the chamber.

12. The apparatus of claim 11, wherein the chamber is formed by a gas directed by the tube.

13. The apparatus of claim 8, further comprising a nozzle in fluid communication with the chamber, wherein the nozzle selectively directs a washer fluid to the window.

14. The apparatus of claim 8, wherein the chamber extends more than half the length of the wiper arm.

15. The apparatus of claim 8, wherein the chamber is formed by gas assist injection molding.

16. A method of forming a windshield wiper apparatus, comprising:
injecting a heated material into a mold cavity;
injecting a fluid into the heated material to expand the heated material to form a member having an external surface that generally conforms to a surface of the mold cavity, wherein the fluid forms a chamber in the member;
forming a first aperture in the member that is connected to the chamber;
forming a second aperture in the member that is connected to the chamber; and
providing a nozzle in one of the first aperture and the second aperture of the member that is in fluid connection with the chamber.

17. The method of claim 16, wherein the fluid is a gas, and injecting the fluid includes injecting a heated gas in a gas assisted injection molding device.

18. The method of claim 16, wherein further comprising pivotally connecting a wiper blade to a portion of the member.

19. The method of claim 16, wherein further coupling a tube to the apparatus, wherein the tube selectively directs a washer fluid to the chamber.

20. The method of claim 19, wherein the tube selectively directs the fluid into the material to form the chamber.
